(19) United States
(12) Patent Application Publication
(10) Pub. No.: US 2009/0065565 A1
(43) Pub. Date: Mar. 12, 2009

(54) SYSTEM, METHOD AND APPARATUS FOR PREVENTING REUSE OF MEDICAL INSTRUMENTS

(75) Inventor: Michael Cao, St. Petersburg, FL (US)

Correspondence Address: HOLLAND & KNIGHT LLP;ATTN: STEFAN V. STEIN/ IP DEPT., POST OFFICE BOX 1288, TAMPA, FL, 33601-1288, US

(73) Assignee: VASCULAR TECHNOLOGIES, INC., St. Petersburg, FL (US)

(21) Appl. No.: 11/854,331

(22) Filed: Sep. 12, 2007

(51) Int. Cl. G06F 17/00; H01H 85/00

(52) U.S. Cl. 235/375; 337/142

(57) ABSTRACT

An application for preventing the reuse of a medical device includes a disposable medical device and a handle for accepting the disposable medical device. The handle physically supports the disposable medical device. A circuit for identifying the disposable medical device is imbedded within the disposable medical device and a circuit for reading a status of the identification is located in the handle. Whether the disposable medical device has been used is determined based upon the status.

### FIELD OF THE INVENTION

This invention relates to the field of medical devices and more particularly to a system for preventing the reuse of sterile medical instruments.

### BACKGROUND OF THE INVENTION

Many surgical procedures require the use of sterile probes or other devices that, once contacting a patient, are no longer sterile and should not be used with another patient. In some instances, because of the cost of such probes or devices, medical facilities attempt to clean or sterilize such probes or devices with heat, alcohol or other known procedures. Due to the nature of such probes and medical devices, it is not always possible to completely sterilize them because of their construction and/or their material composition. In such devices, the patient will not know that the device was previously used until a disease or infection occurs; when it is too late.

Prior to the present invention, other methods of preventing reuse were employed. One method includes packaging the probe or device in a non-resealable encapsulation. This method informs the medical practitioners that the probe or device has been previously used, but often the patient is unaware of such and an overly cost-cutting medical facility would be free to reuse such probes or devices.

Another method used is to at least partially fabricate the probe or device out of a material that degrades during any attempted sterilization. For example, a plastic handle that melts under the heat of boiling water or a plastic that deforms when contacted by alcohol or other petroleum products. Unfortunately, it is difficult to find materials that cover all forms of sterilization. Furthermore, such materials make it difficult to sterilize during manufacture. Worse yet, in rare cases, a practitioner may choose to simply wipe off the probe or device in an effort to maximize profits.

What is needed is a system that will prevent the intentional and non-intentional reuse of medical devices.

### SUMMARY OF THE INVENTION

In one embodiment, a system for preventing the reuse of a medical device is disclosed including a disposable medical device and a handle for accepting the disposable medical device. The handle physically supports the disposable medical device. A circuit for identifying the disposable medical device is imbedded within the disposable medical device and a circuit for reading a status of the identification is located in the handle. Whether the disposable medical device has been used is determined based upon the status.

In another embodiment, a method of preventing reuse of a disposable medical device is disclosed including providing a disposable medical device with a circuit for identifying itself imbedded within the disposable medical device and a handle for accepting the disposable medical device. The handle physically supports the disposable medical device has a circuit for reading a status of the circuit for identifying the disposable medical device. The method continues with reading the status from the circuit for identifying and determining if the status indicates the disposable medical device has been previously used. If the status indicates the disposable medical device has been previously used, the disposable medical device is prevented from being used.

In another embodiment, a system for preventing the reuse of a medical probe is disclosed including a disposable medical probe with at least two electrical conductors and a handle for removably accepting the disposable medical probe. The handle physically supports the disposable medical probe and electrically couples to the electrical conductors. A device for identifying the disposable medical probe is imbedded within the disposable medical probe and a device for reading a status of the device for identifying is located in the handle. A controller determines if the disposable medical probe has been previously used based upon the status.

In another embodiment, a system for preventing the reuse of a medical probe is disclosed including a disposable medical hemorrhoid probe having two electrical conductors and a handle for removably accepting the disposable medical hemorrhoid probe. The handle physically supports the disposable medical hemorrhoid probe and electrically couples to the two electrical conductors. A tuned circuit is electrically connected to the two electrical conductors and imbedded within the disposable medical hemorrhoid probe for identifying each disposable medical hemorrhoid probe. A sweep frequency generator is electrically coupled to the two electrical conductors through the handle and the impedance of the tuned circuit over the two electrical conductors is measured through the handle while the sweep frequency generator is operational to determine an identification of the probe.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system of a first embodiment of the present invention.

FIG. 2 illustrates a schematic view of a system of a second embodiment of the present invention.

FIGS. 2A, 2B and 2C illustrate schematic views of ID devices of the second embodiment of the present invention.

FIG. 3 illustrates a schematic view of a system of a third embodiment of the present invention.

FIG. 4 illustrates a plan view of a typical medical probe of all embodiment of the present invention.

FIG. 5 illustrates an isometric view of a typical medical probe of all embodiment of the present invention.

FIG. 6 illustrates an isometric view of a typical medical probe handle of all embodiment of the present invention.

FIG. 7 illustrates a flow chart of the first embodiment of the present invention.

FIG. 8 illustrates a flow chart of the second embodiment of the present invention.

FIG. 9 illustrates a flow chart of the third embodiment of the present invention.

FIG. 10 illustrates a first flow chart of an alternate method of the third embodiment of the present invention.

FIG. 11 illustrates a second flow chart of the alternate method of the third embodiment of the present invention.

FIG. 12 illustrates a schematic diagram of a network according to the alternate method of the third embodiment of the present invention.

FIG. 13 illustrates a schematic diagram of a controller of all embodiments of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. The present invention describes a method of preventing reuse of surgical instruments. Although the description is directed toward a disposable surgical probe used in the treatment of hemorrhoids, the methods and apparatus apply to many other types of surgical instruments and probes, all of which are anticipated and included here within. In some embodiments, the probe is a monopolar hemorrhoid probe. Usually, such systems include a disposable portion (e.g., a probe that comes in contact with the patient), a handle into which the probe is inserted and held and, a base station connected to the probe for providing power and therapeutic signals.

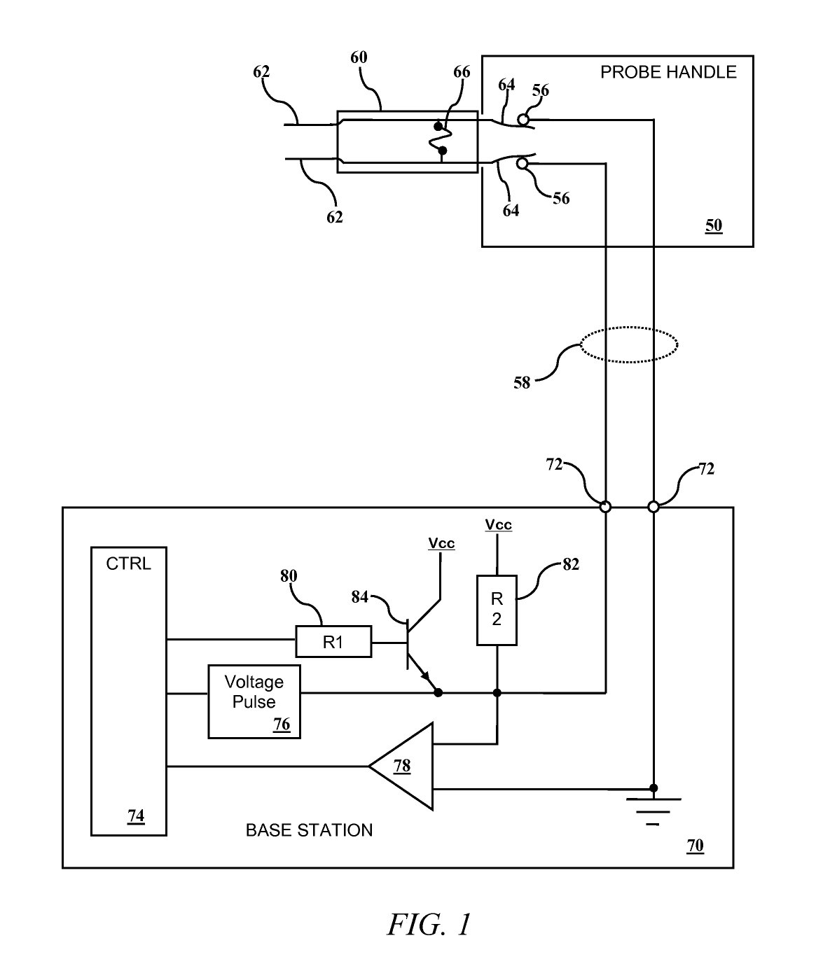

Referring to FIG. 1, a schematic view of a system of a first embodiment of the present invention will be described. In this embodiment, a fuse 66 is embedded in the probe 60. In this embodiment, the fuse is shown bridging the two probe conductors 64, while in other embodiments having more than two conductors between the probe 60 and probe handle 50, other fuse arrangements are envisioned. The fuse 66 is an indicator that identifies whether the probe 60 has been previously used. If the fuse 66 is conductive, it is believed that the probe 60 has not been previously used. If the fuse 66 is blown (non-conductive), it is believed that the probe 60 has been previously used. In this embodiment, the probe 60 has two probe tip conductors 62 that are electrically coupled to connector pins 64 in the base of the probe 60. The connector pins 64 mate with connector pins 56 within the probe handle 50, which are in electrical communication with a base station 70 through a cable 58 or other means. In some embodiments, the cable 58 is electrically plugged into the base station 70 through a connector 72 while in other embodiments, the cable 58 is hard-wired (captured) to the base station 70. The base station 70 includes a programmable controller 74 for performing the reuse testing operation and for providing electrical signals to the probe 60 for medical purposes. In this example, one leg of the probe conductors 62/64/56/58 is biased to a voltage potential (Vcc) by a resistor R2 82 while the other probe conductor 62/64/56/58 is held to ground potential. R2 82 is of high enough resistance to not interfere with the medical purpose of the device while having a low enough resistance to raise the voltage over the probe 60 high enough to detect the presence/absence of the fuse; for example, a 10 KΩ resistor. The medical electrical drivers are known in the industry and, for example, include a voltage pulse driver 76. Other types of medical electrical drivers are known in the industry and the present invention is not limited to any particular type.

An operational amplifier or comparator or other voltage detecting circuit 78 detects the voltage across the probe 60 and is coupled to an input of the controller 74. Therefore, if there is voltage over the probe 60, the controller determines the fuse 66 is absent (used probe) and if there is little or no voltage over the probe 60, the controller 74 determines the fuse 66 is present (new probe). Once it is determined that the fuse 66 is present (new probe), the controller 74 outputs a logic signal to a current/voltage driver transistor 84, in some embodiments through a current-limit resistor R1 (typically 1 KΩ). This voltage/current is sufficient to burn the fuse 66 and prevent reuse of the probe 60. The controller 74 first measures the voltage over the probe 60 using the voltage detection device 78 and if voltage is present, prevents use of the probe 60 because it has been used. If voltage is not present, it determines that the probe has not been already used and drives the transistor 84 to provide enough current to burn/blow the fuse 66, signaling the probe 60 is now used. In some embodiments, a current limiting resistor 80 couples the controller 74 with the transistor 84.

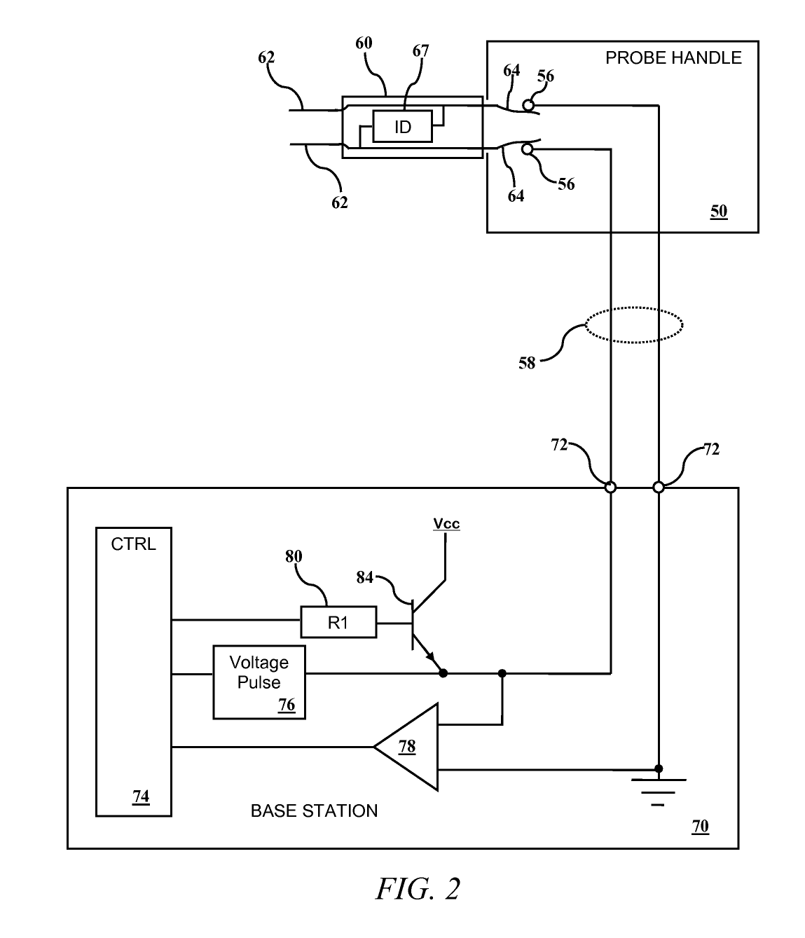

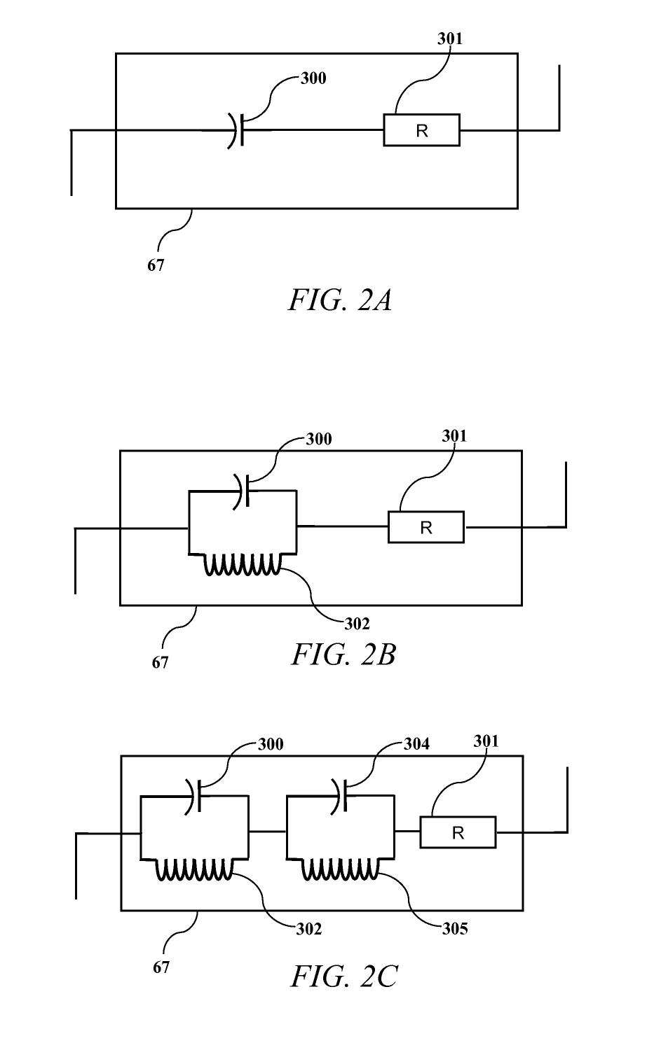

Referring to FIG. 2 along with FIG. 2A, FIG. 2B and FIG. 2C, a system of a second embodiment of the present invention will be described. In this embodiment, an ID device 67 is embedded in the probe 60. In this embodiment, the ID device 67 is shown bridging the two probe conductors 64, while in other embodiments having more than two conductors between the probe 60 and probe handle 50, other ID device 67 arrangements are envisioned. The ID device 67 is an indicator of whether the probe 60 has been previously used. The ID device 67 has a unique or statistically unique characteristic that is detectable by the base station 70 through the probe handle 50. Many ID devices 67 are envisioned including tuned circuits such as capacitors, inductors and parallel or serial capacitors and inductors. In some embodiments, the ID device 67 is a ROM/EPROM/EEPROM/FLASH, preferably a serial version to reduce pin/conductor requirements. In all examples of ID devices 67, each device has a statistically unique characteristic or code. For example, a capacitor/inductor in parallel forms a tuned circuit that provides a notch filter providing a low impedance starting at a first frequency and ending at a second frequency. The frequency at which the impedance changes from the low impedance to the high impedance is the cross-over frequency. Each probe 60 is fabricated with a different capacitance and inductance and therefore, each probe 60 has a different impedance vs. frequency response and one or more cross-over frequencies. Measuring this response yields a statistically unique value of set of cross over frequencies that are used to determine if a probe 60 has already been used. It is anticipated that, due to a finite number of capacitor and inductor values possible, after a certain number of probes 60 have been used, the base station will need to be reset to “forget” all of the values already seen. In that, if there are 100 possible combinations of capacitors and inductors, after using 100 probes 60, the base station need be reset to allow for the next 100 probes, etc.

The base station 70 keeps track of which statistical unique codes have been used and, if finding a probe 60 with an already used statistically unique code, prevents its use.

In this embodiment, the probe 60 has two probe tip conductors 62 that are electrically coupled to connector pins 64 in the base of the probe 60. The connector pins 64 mate with connector pins 56 within the probe handle 50, which are in electrical communication with a base station 70 through a cable 58 or other means. In some embodiments, the cable 58 is electrically plugged into the base station 70 through a connector 72 while in other embodiments, the cable 58 is hard-wired (captured) to the base station 70. The base station 70 includes a programmable controller 74 for performing the reuse testing operation and for providing electrical signals to the probe 60 for medical purposes. The medical electrical drivers are known in the industry and, for example, include a voltage pulse driver 76. Other types of medical electrical drivers are known in the industry and the present invention is not limited to any particular type.

An analog to digital converter, operational amplifier or comparator or other voltage detecting circuit 78 detects the voltage across the probe 60 and, hence the impedance when a frequency is applied to the conductors. It is coupled to an input of the controller 74. Therefore, the impedance of the probe 60 is measurable by the controller 74 to determine a statistically unique identification. This statistically unique identification is used to determine if the probe 60 was a previously used probe (e.g., that particular identification or code was previously detected). To determine the impedance of the probe 60, a series or sweep of frequencies are generated by the controller 74 and amplified, by example, by a transistor 84 while the voltage across the probe is measured by the voltage detection device 78 (operational amplifier, comparator, analog to digital controller, etc). The voltage across the probe 60 will increase as the impedance of the ID device 67 increases (e.g., a cross over frequency). Detection of the changes in voltage measured by the controller 74 is used to determine the cross over frequencies of the probe 60, thereby determining its statistically unique footprint. In some embodiments, a current limiting resistor 80 couples the controller 74 with the transistor 84. It is envisioned that multiple parallel and/or serial combinations of capacitors, resistors and inductors will be used to provide a larger number of statistically unique footprints (see FIGS. 2A, 2B and 2C). In one example, an ID device 67 has a capacitor 300 in series with a resistor 301 to create a low-pass filter having a crossover frequency, f₁ In another example, an ID device 67 has a capacitor 300 in parallel with an inductor 302, both in series with a resistor 301 to create a filter having a first cross over frequency, f₁ and a second cross over frequency f₂. In another example, an ID device 67 has two sets of parallel capacitors 300/304 and inductors 302/305 in series with a resistor 301 to create a dual-notch filter having two notch frequencies, f₁ and f₂. Therefore, assuming 100 possible unique combinations of capacitors and inductors, 9,900 statistically unique combinations are possible (100 possible first notch frequencies multiplied by 99 possible second notch frequencies assuming the same frequency is not reused). Other combinations of tuned circuits are envisioned. For example, a band-pass filter with a frequency response having a low impedance from zero to f₁ (first cross over frequency) and having a high impedance from f₁ to f₂ (second cross over frequency) then a low impedance at frequencies higher than f₂.

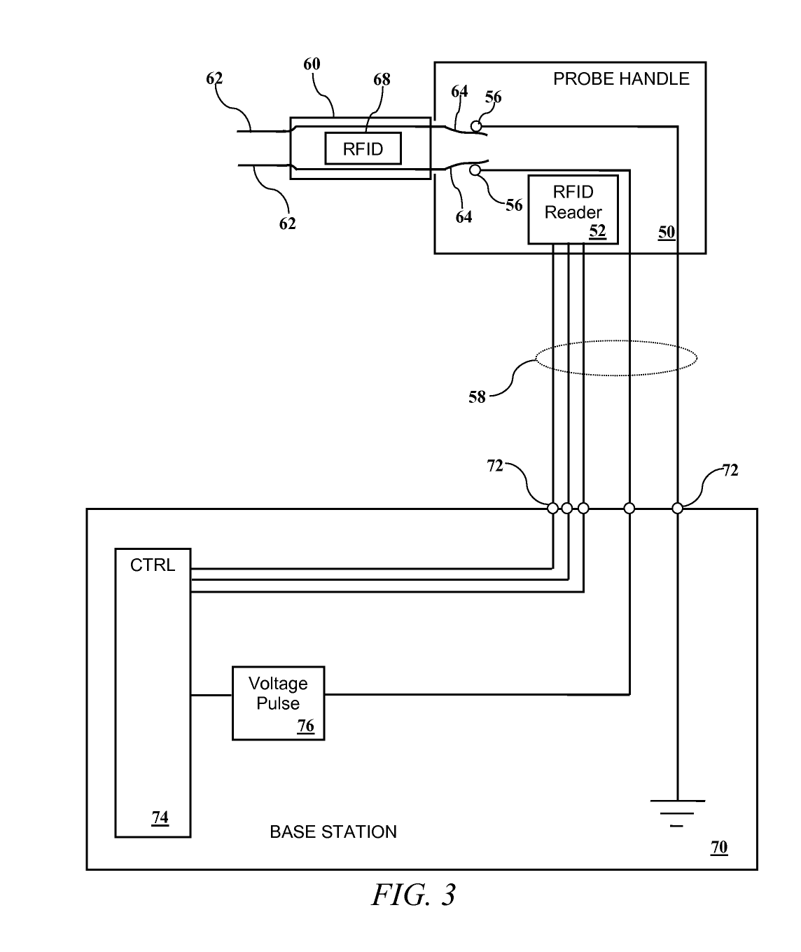

Referring to FIG. 3, a schematic view of a system of a third embodiment of the present invention will be described. RFIDs 68 are known in the industry as are RFID readers. RFIDs (radio frequency identification devices) 68 contain a data stream that is usually unique, providing a serial number. The serial number is read by radio frequency (RF) radiation from the RFID reader 52 through a wireless connection. The RFID 68 uses parasitic RF energy to power itself and transmit its identification code or serial number. In some embodiments, the RFID reader 52 is integrated into the probe handle 50 (as shown in FIG. 3) while in other embodiments, it is integrated into the base station 70 or external to the base station 70. It is preferred that the RFID reader 52 be located in the probe handle 50 for several reasons. First, its close proximity to the probe 60 allows more accurate readings of the RFID 68 within the probe utilizing less transmission power. Second, because lower transmission power is used, the RFID 52 reader is less likely to erroneously read an RFID 52 located in a probe 60 that is not installed in the probe handle 50.

The RFID reader 52 is communicatively coupled to the controller 74, in this embodiment by the probe cable 58 and optional probe cable connector 72. The method of determining reuse will be described in detail later. It consists of reading the RFID 68 before use and looking in a database to determine if the serial number of the RFID 68 has already been used. If it has already been used, use of the probe 60 is prevented. If it hasn't been used, the serial number is added to the database and the probe 60 is allowed to be used.

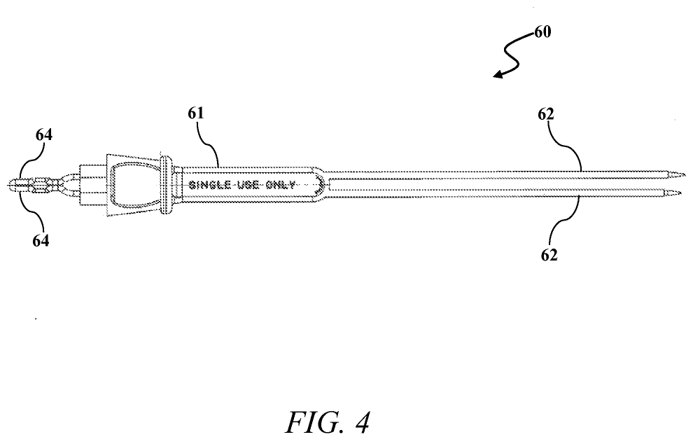

Referring to FIG. 4, a plan view of a typical medical probe of all embodiment of the present invention will be described. This probe 60 is for the electrical treatment of hemorrhoids. It is envisioned that the described method of preventing reuse applies to many other types of medical devices and a probe for hemorrhoid treatment is an example of such. The method utilizing an RFID 68 adapts well to devices that have no electrical connection to the probe handle 50. The probe 60 of this example has two probe connectors 64 at the connector end and two probe tips 62 at the tip end. The probe identification device 66/67/68 is housed within the probe body 61.

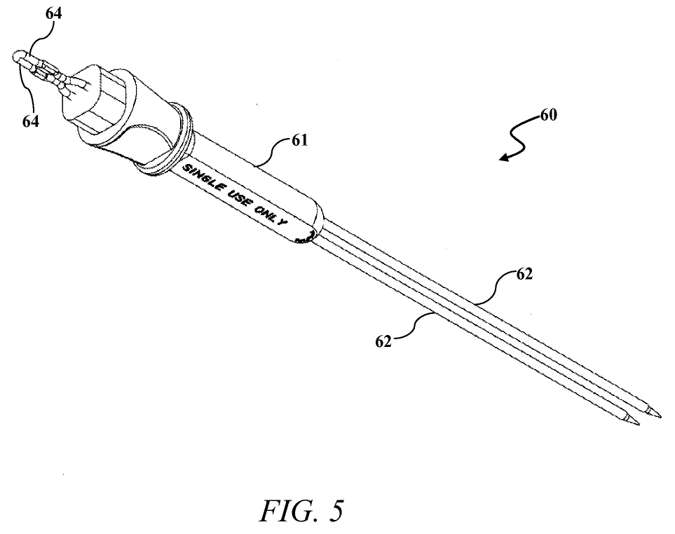

Referring to FIG. 5, an isometric view of a typical medical probe of all embodiment of the present invention will be described. This probe 60 is for the electrical treatment of hemorrhoids. It is envisioned that the described method of preventing reuse applies to many other types of medical devices and a probe for hemorrhoid treatment is an example of such. The probe 60 of this example has two probe connectors 64 at the connector end and two probe tips 62 at the tip end. The probe identification device 66/67/68 is housed within the probe body 61.

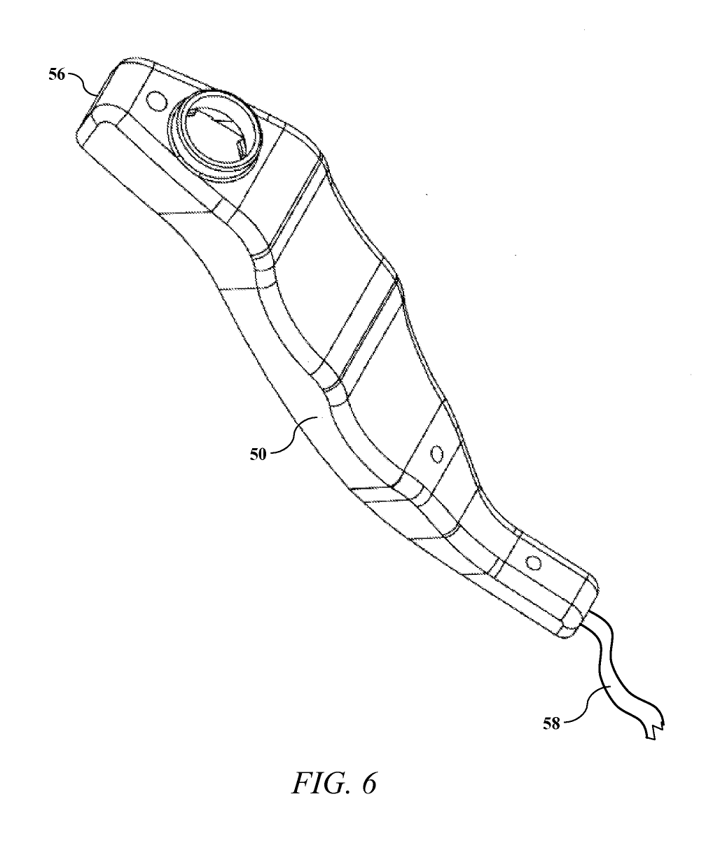

Referring to FIG. 6, an isometric view of a typical medical probe handle of all embodiment of the present invention will be described. Although many different sizes, shapes and configurations of probe handles 50 are envisioned, the probe handle 50 shown is an example for use with the probe 60 of FIGS. 4 and 5. The probe handle 50 has a connector end 56 for accepting the electrical connections 64 of the probe 60 and an electrical cable 58 for connecting with the base station 70. In some embodiments, indicators and/or controls are integrated into the probe handle 50 (not shown).

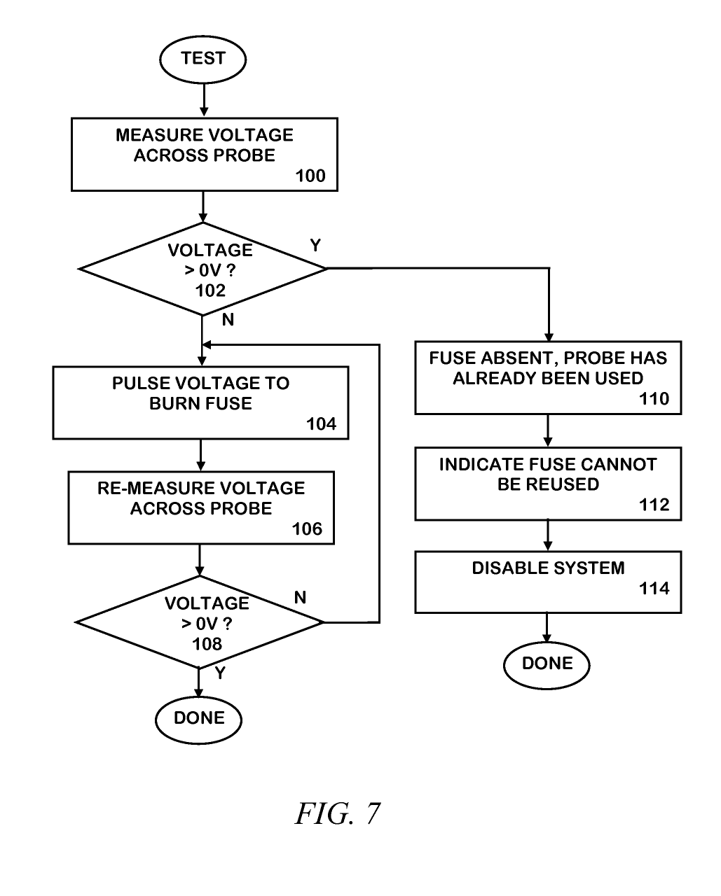

Referring to FIG. 7, a flow chart of the first embodiment of the present invention will be described. The method begins with measuring the voltage 100 across the probe 60. If the voltage is present 102 (some voltage over 0V), it is determined that the fuse 66 is absent 110 and, therefore, the probe 60 is prevented from being reused. An indication that the probe 60 cannot be reused is made 112 (e.g., illuminating a red LED—not shown). In some embodiments, the system is then disabled 114 preventing any operation of the probe 60.

If there is little or no voltage measured 102, a voltage or current pulse is emitted 104 over the probe 60 to burn the fuse 66. In some embodiments, the voltage across the probe 60 is re-measured 106 to make sure the fuse 66 is blown. If the voltage is present 108 (some voltage over 0V), it is determined that the fuse 66 has blown and the probe 60 is ready for use. If the voltage is not present 108 (approximately 0V), it is determined that the voltage/current pulse did not blow the fuse 66 and the previous two steps are repeated in an attempt to blow the fuse 66. In some embodiments (not shown), these steps are repeated a fixed number of times before disabling the probe 60. For example, someone might attempt to short the probe tip to allow for reuse.

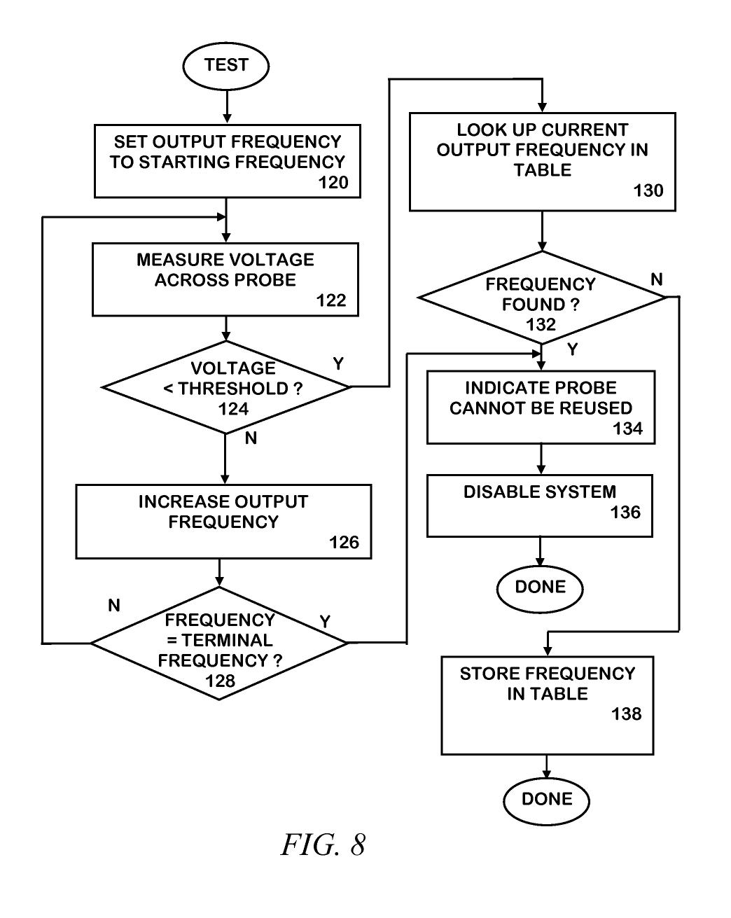

Referring to FIG. 8, a flow chart of the second embodiment of the present invention will be described. To determine if a probe of the second embodiment of the present invention has already been used, the base station performs a sweep generator function by setting an output frequency to a starting frequency 120. At each frequency, the base station measures the voltage 122 across the probe 60. If the probe 60 has a higher impedance at that frequency, the voltage across the probe 60 will be higher and if the probe 60 has a lower impedance at that frequency, the voltage across the probe 60 will be lower. The example of FIG. 8 uses an identification system of the second embodiment having a capacitor 300 in series with a resistor 301 (see FIG. 2A). In this, the probe 60 acts like a low-pass filter in that it has a high impedance at low frequencies and a low impedance at high frequencies, the cross-over frequency is determined by the value of the capacitor 300. At each output frequency, the voltage is measured or compared to a threshold 124, with a comparator, operational amplifier or analog-to-digital converter 78. If the voltage is not less than the threshold 124, the output frequency is increased 126 and, if a terminal frequency is not reached 128, previous steps are repeated to measure the voltage over the probe 60, etc. If the terminal frequency is reached 128, the probe 60 is declared used and cannot be reused 134, therefore the system is disabled 136. If the voltage across the probe 60 is less than the threshold (e.g., the tuned circuit is a low impedance at this frequency), the frequency is looked up in a table 130 and if found, it is determined that the probe 60 was previously used and cannot be reused 134, therefore the system is disabled 136. The current frequency (frequencies) is stored in the table 138 to prevent future reuse of the current probe 60.

In alternate embodiments, multiple tuned frequencies are tracked and recorded and looked up in the table or database (e.g., the embodiment of FIG. 2C).

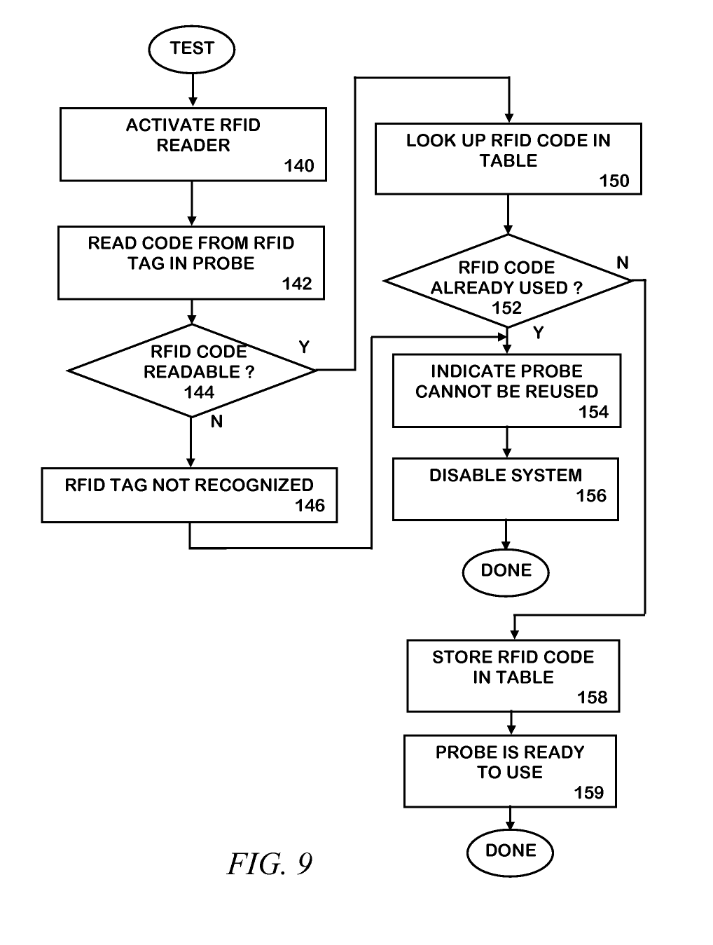

Referring to FIG. 9, a flow chart of the third embodiment of the present invention will be described. This embodiment begins with activating 140 the RFID reader 52 to read the code 142 from the RFID 68. If the code is not readable 144, the RFID is not recognized 146 and the system indicates the probe 60 cannot be used 154 and, in many embodiments, the system is disabled 156 until a different probe 60 is installed. If the code is read 144, the code is looked up in a RFID code table or database 150. If the code has already been used 152, the system indicates the probe 60 cannot be used 154 and, in many embodiments, the system is disabled 156 until a different probe 60 is installed. If the RFID code has not already been used 152, the RFID code is stored in the table or database 158 to prevent the current probe 60 from being reused in the future and the probe 60 is ready for use 159.

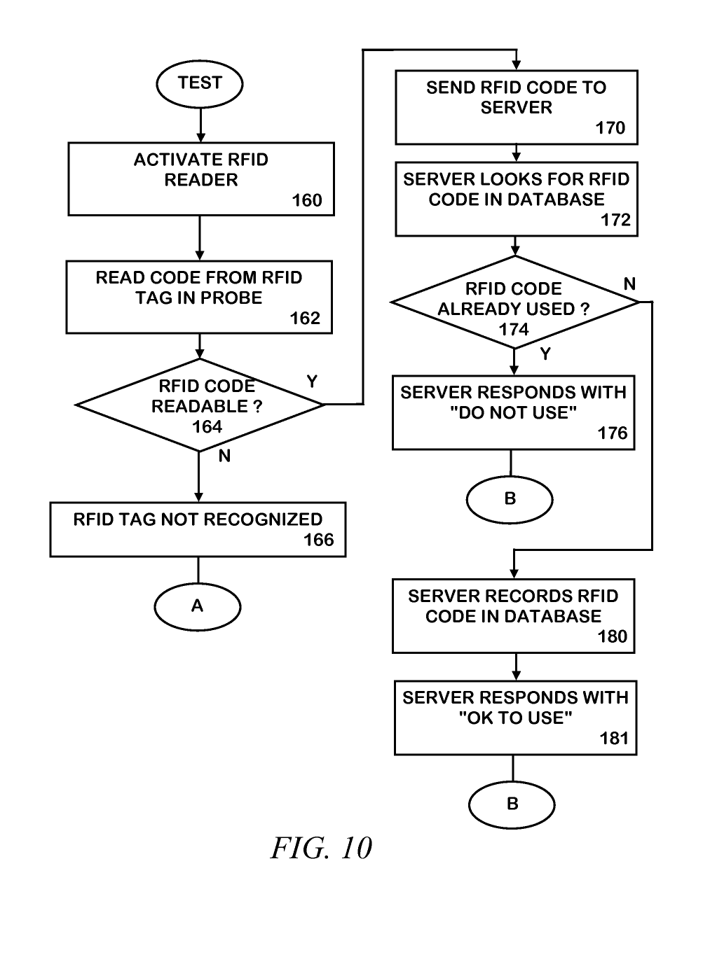

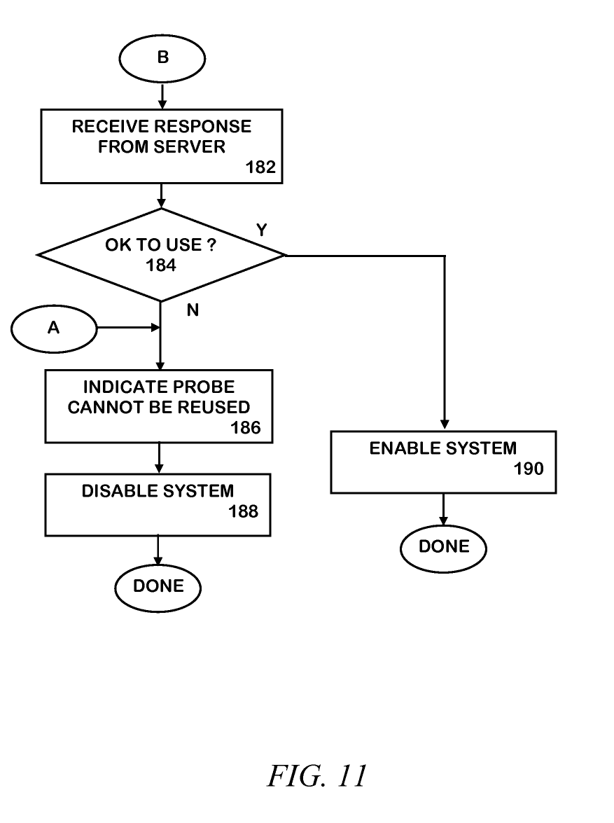

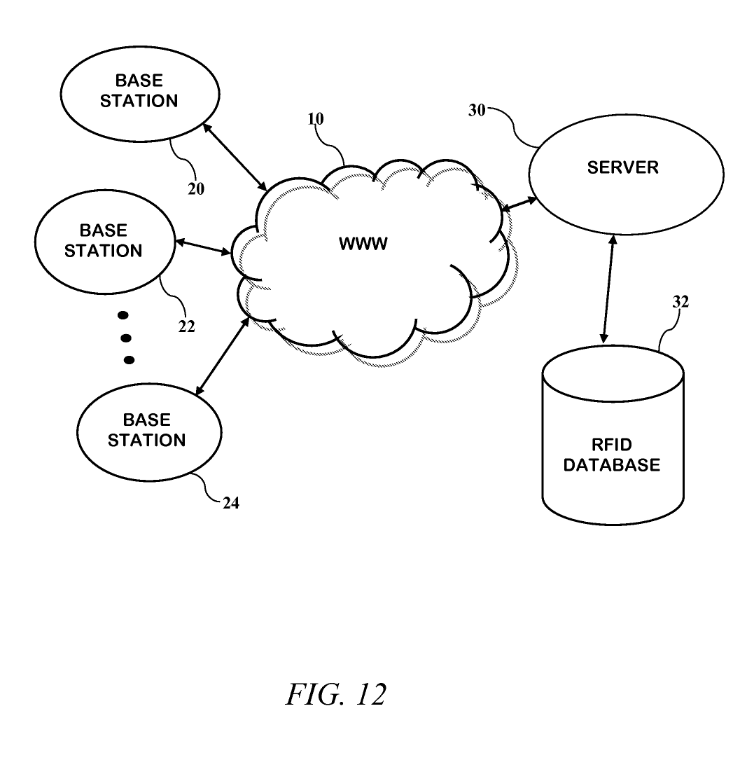

Referring to FIGS. 10 and 11, a first and second flow chart of an alternate method of the third embodiment of the present invention will be described. This embodiment begins with activating 160 the RFID reader 52 to read the code 162 from the RFID 68. If the code is not readable 164, the RFID is not recognized 166 and the system indicates the probe 60 cannot be used 186 and, in many embodiments, the system is disabled 188 until a different probe 60 is installed. If the code is read 144, the code is sent to a server 170 through means known in the industry including sending the code through the internet 10 (see FIG. 12). Within the server, the code is looked up in a RFID code table or database 172. If the code has already been used 174, the server responds with an indication that the probe 60 should not be used 176. If the RFID code has not already been used 174, the server adds the code to the table or database 180 to prevent future use of the same probe and responds with an indication that the probe is valid and is ok to use 181. After the response is received 182 at the controller, the response from the server is tested to determine if it is ok to use 184 the probe 60, If it is ok to use the probe 60, the system is enabled 190 If it is not ok to use the probe 60 (e.g., the probe was previously used), the system indicates the probe 60 cannot be used 186 and, in many embodiments, the system is disabled 188 until a different probe 60 is installed.

Referring to FIG. 12, a schematic diagram of a network according to the alternate method of the third embodiment of the present invention will be described. This exemplary diagram shows how multiple base stations 20/22/24 communicate with a server 30 through the Internet 10 as described with FIGS. 10 and 11. The server is interfaced with an RFID table or database 32 for determining if a probe 60 (e.g., RFID code) has previously been used by any base station connected to the server.

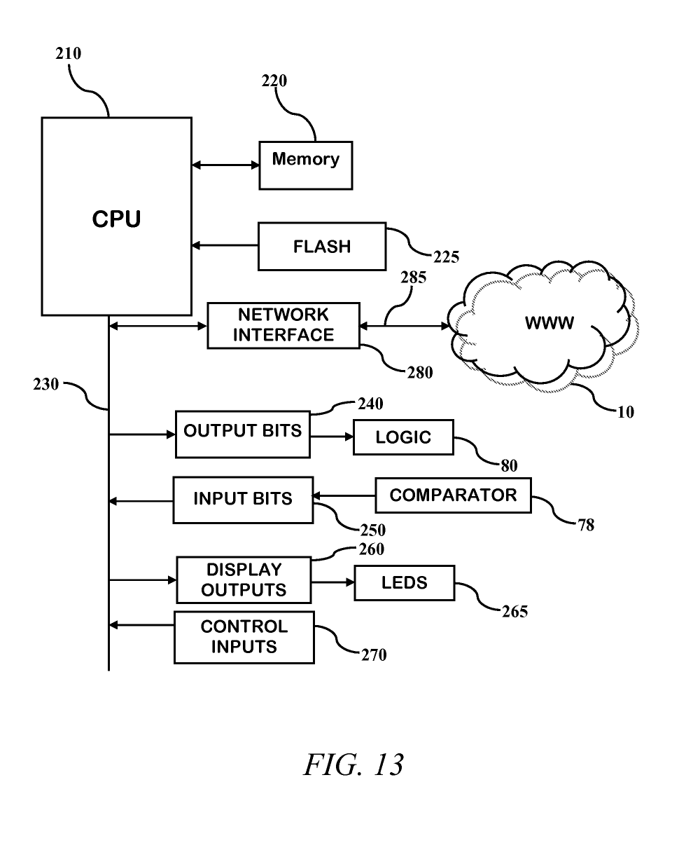

Referring to FIG. 13, a schematic diagram of a controller of all embodiments of the present invention will be described. Many different computer architectures are known that accomplish similar results in a similar fashion and the present invention is not limited in any way to any particular computer system. In this exemplary system, a processor 210 is provided to execute stored programs that are generally stored for execution within a memory 220. The processor 210 can be any processor, for example an Intel® 80C51 CPU or the like. The memory 220 is connected to the processor and can be any memory suitable for connection with the selected processor 210, such as SRAM, DRAM, SDRAM, RDRAM, DDR, DDR-2, etc. Firmware is stored in firmware storage 225 that is connected to the processor 210 and may include initialization software known as BIOS. This initialization software usually operates when power is applied to the system or when the system is reset. In some embodiments, the software is read and executed directly from the firmware storage 225.

Also connected to the processor 210 is a system bus 230 for connecting to peripheral subsystems such as a network interface 280, output bits 240, input bits 250, display outputs 260 and control inputs 270. The display outputs are any known display device including LEDs 265, numeric displays, alpha-numeric displays, lamps, etc. The control inputs 270 include any known control input 270 including switches, push buttons, rotary switches, thumbwheel switches, dip switches, etc.

The network interface 280 connects the computer-based system to the world-wide-web 10 through a link 285 which is, in some embodiments, a high speed link such as a cable broadband connection, a Digital Subscriber Loop (DSL) broadband connection, a T1 line or a T3 line.

The output bits 240 control the logic through, for example, a resistor 80 and transistor 84. Some output bits 240 control the therapeutic outputs 76 of the system of the present invention.

The input bits 250 interface to the comparator/operational amplifier/analog-to-digital converter 78 to measure the voltage drop over the probe and/or impedance. Some input bits 240 are used to read the RFID code from the RFID reader 52.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for preventing the reuse of a medical device, the system comprising:
a disposable medical device;
a handle for accepting the disposable medical device, the handle physically supporting the disposable medical device;
a means for identifying the disposable medical device imbedded within the disposable medical device;
a means for reading a status of the means for identifying the disposable medical device, the means for reading located in the handle; and
a means for determining if the disposable medical device has been used based upon the status.

2. The system for preventing the reuse of a medical device of claim 1, wherein the disposable medical device is a monopolar electrical probe for treating hemorrhoids.

3. The system for preventing the reuse of a medical device of claim 1, wherein the means for identifying the disposable medical device is a fuse and the status is “used” if the fuse is blown and the status is “new” if the fuse is intact.

4. The system for preventing the reuse of a medical device of claim 1, wherein the means for identifying the disposable medical device is a tuned circuit.

5. The system for preventing the reuse of a medical device of claim 1, wherein the means for identifying the disposable medical device is a radio frequency identification device.

6. The system for preventing the reuse of a medical device of claim 4, wherein the tuned circuit comprises at least one capacitor.

7. The system for preventing the reuse of a medical device of claim 4, wherein the tuned circuit is in series with a resistor and the tuned circuit comprises at least one capacitor in parallel with at least one inductor.

8. A method of preventing reuse of a disposable medical device, the method comprising:
providing a disposable medical device and a handle for accepting the disposable medical device, the handle physically supporting the disposable medical device, the disposable medical device having a means for identifying the disposable medical device imbedded within the disposable medical device and the handle having a means for reading a status of the means for identifying the disposable medical device,
reading the status from the means for identifying;
determining if the status indicates the disposable medical device has been previously used; and
if the status indicates the disposable medical device has been previously used, preventing the disposable medical device from being reused.

9. The method of claim 8, wherein the means for identifying is a fuse and the step of determining includes:
measuring the impedance of the fuse;
if the impedance is low, the status indicates the disposable medical device is new; and
if the impedance is high, the status indicates the disposable medical device has been previously used.

10. The method of claim 8, wherein the means for identifying is a tuned circuit and the step of determining includes:
measuring at least one cross-over frequency of the tuned circuit;
searching a table for an entry having all of the at least one cross-over frequencies;
if the table is void of the entry having all of the at least one cross-over frequencies, the disposable medical device is new; and
if the table has the entry having all of the at least one cross-over frequencies, the disposable medical device has been previously used.

11. The method of claim 10, further comprising the step of adding the at least one cross-over frequencies to the table to prevent further use of the disposable medical device.

12. The method of claim 10, wherein the means for identifying is an RFID and the step of determining includes:
reading a code of the RFID from the RFID;
searching a table for an entry having the code of the RFID;
if the table is void of the entry having the code of the RFID, the disposable medical device is new; and
if the table has the entry having the code of the RFID, the disposable medical device has been previously used.

13. The method of claim 12, further comprising the step of adding the code of the RFID to the table to prevent further use of the disposable medical device.

14. A system for preventing the reuse of a medical probe, the system comprising:
a disposable medical probe having at least two electrical conductors;
a handle for removably accepting the disposable medical probe, the handle physically supporting the disposable medical probe and electrically coupling to the at least two electrical conductors;
a means for identifying the disposable medical probe imbedded within the disposable medical probe;
a means for reading a status of the means for identifying the disposable medical probe, the means for reading located in the handle; and
a means for determining if the disposable medical probe has been previously used based upon the status.

15. The system for preventing the reuse of a medical device of claim 14, wherein the disposable medical probe is a disposable monopolar electrical probe for treating hemorrhoids.

16. The system for preventing the reuse of a medical device of claim 14, wherein the means for identifying the disposable medical probe is a fuse bridging two of the at least two electrical conductors and the status is “used” if the fuse is blown and the status is “new” if the fuse is intact.

17. The system for preventing the reuse of a medical device of claim 14, wherein the means for identifying the disposable medical device is a tuned circuit bridging two of the at least two electrical conductors.

18. The system for preventing the reuse of a medical device of claim 14, wherein the means for identifying the disposable medical device is a radio frequency identification device.

19. The system for preventing the reuse of a medical device of claim 17, wherein the tuned circuit comprises at least one capacitor connected across the two of the at least two electrical conductors.

20. The system for preventing the reuse of a medical device of claim 17, wherein the tuned circuit is in series with a resistor and the tuned circuit comprises at least one capacitor in parallel with at least one inductor.

21. A system for preventing the reuse of a monopolar medical probe, the system comprising:
a disposable medical monopolar hemorrhoid probe having two electrical conductors;
a handle for removably accepting the disposable medical monopolar hemorrhoid probe, the handle physically supporting the disposable medical monopolar hemorrhoid probe and electrically coupling to the two electrical conductors;
a tuned circuit for identifying the disposable medical monopolar hemorrhoid probe imbedded within the disposable medical monopolar hemorrhoid probe, the tuned circuit electrically connected to the two electrical conductors;
a sweep frequency generator electrically coupled to the two electrical conductors through the handle; and
a means for measuring the impedance of the tuned circuit over the two electrical conductors through the handle while the sweep frequency generator is operational.

22. The system for preventing the reuse of a monopolar hemorrhoid probe of claim 21, whereas the tuned circuit determines a statistically unique identification comprising at least one cross-over frequency of the tuned circuit.

23. The system for preventing the reuse of a monopolar hemorrhoid probe of claim 22, wherein a first disposable medical monopolar hemorrhoid probe has a first tuned circuit, the first tuned circuit having a first at least one cross-over frequency and a second disposable medical monopolar hemorrhoid probe having a second tuned circuit, the second tuned circuit having a second at least one cross-over frequency and at least one frequency from the first at least one cross-over frequency differs from at least one frequency from the second at least one cross-over frequency.
